(19) United States
(12) Patent Application Publication
(10) Pub. No.: US 2020/0323236 A1
(43) Pub. Date: Oct. 15, 2020

(54) FROZEN FOOD PRODUCTS CONTAINING SUPERFOOD STABILIZERS AND METHODS OF MAKING THE SAME

(71) Applicant: SWEET NOTHINGS, INC., Menlo Park, CA (US)

(72) Inventors: Brook PORTER, Menlo Park, CA (US); Beth PORTER, Menlo Park, CA (US)

(21) Appl. No.: 16/845,379

(22) Filed: Apr. 10, 2020

Related U.S. Application Data
(60) Provisional application No. 62/833,020, filed on Apr. 12, 2019.

(51) Int. Cl. A23G 9/42; A23L 3/36

(52) U.S. Cl. CPC A23G 9/42; A23L 3/36

(57) ABSTRACT

Stable frozen food compositions with a smooth texture and methods of preparing thereof that include the use of a flax and/or chia composition to replace industrial stabilizers are described. The flax and/or chia can be added individually or combined together.

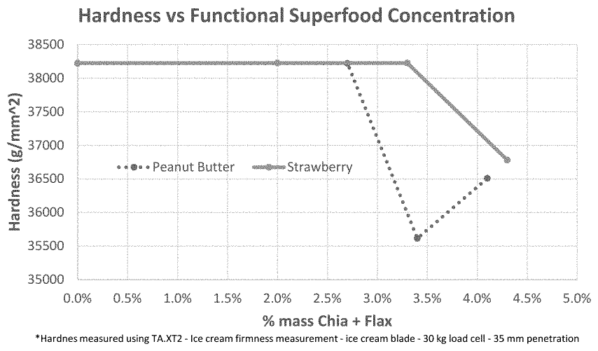

### TECHNICAL FIELD

The present disclosure is directed to frozen food products in general and to aerated frozen food products containing superfood stabilizers in particular.

### BACKGROUND

Stabilizers are commonly used in ice creams and other aerated frozen foods to reduce ice crystal growth by influencing viscosity and other rheological properties to limit the mobility of water in the unfrozen, aqueous portion of the mixture. The resulting characteristics of the ice cream include smoother, creamier texture, improved resistance to melting, and reduced ice crystal growth during storage and freezing/thawing occurring during transportation and storage. Common industrial stabilizers for this application include carboxylmethylcellulose, xantham gum, guar gum, carrageenan, pectin, locust bean gum and sodium alginate.

Industrial stabilizers require small mass fraction additions to achieve enhanced viscosity or emulsification characteristics, typically between 0.1-2%. They are often produced through a range of separation or concentration processes or via synthetic chemistry. Their use can result in overly aerated, chewy, or otherwise low-quality ice cream texture.

As consumer trends towards plant-based, whole-food diets grow, there is a value in identifying whole plants or combinations of whole plants that can achieve similar functionality to industrial stabilizers in foods. Ideally these whole plants could also deliver valuable nutrition in addition to their functionality.

Within the ice-cream and frozen-treat category, non-dairy alternatives have grown in market share in recent years. These products often have lower fat content than traditional dairy-based ice creams, which can result in greater ice-crystal formation and a harder final product texture. To counterbalance lower fat content, one approach is to increase sugar concentration to help reduce the freezing point of the solution. For non-dairy alternative ice creams without added sugar, addressing these challenges is even more difficult.

### SUMMARY

We have identified combinations of superfoods, specifically chia seed and flax seed, which at the right ratios, achieve similar viscosity enhancements and emulsification characteristics to common industrial stabilizers.

These stabilizers have the benefit of providing a range of nutritional value, including Alpha Lineolenic Acid (ALA) Omega-3 fatty acids, lignans, high-quality protein and dietary fibers. Flax seed has potential benefits on immune function, inflammatory diseases and reduced likelihood of platelet aggregation and certain types of cancer, especially breast and colon cancer. Chia seeds contain high portions of alpha linolenic acid and dietary fiber.

The identified ratios of superfoods have demonstrated improved and smoother texture in various frozen food confections, including non-dairy, no-added-sugar formulations—specifically those based on whole fruits. By replacing common industrial stabilizers for ice creams, the proposed use of superfoods has the added benefit of increasing nutritional content and dietary fibers. The resulting frozen food products have a desired texture, ice crystal formation, and hardness.

### FIGURE

The FIGURE is a plot of hardness of the frozen food product versus percent weight of flax and chia in the frozen food product.

### DESCRIPTION

In one embodiment, industrial stabilizers used in frozen treats and ice creams are replaced with functional superfoods to achieve similar increased viscosity, improved stabilization of mixtures, enhanced smoother textures when frozen, reduced hardness and reduced ice crystal formation.

In one embodiment, the superfoods include flax seed, chia seed, acacia fiber or a combination of any two or all three of flax, chia seed and acacia fiber.

Flax seed is preferably ground. Chia seed can be whole or ground. Acacia fiber is preferably ground. Preferably, a combination of any two or all three of ground flax seed, acacia fiber and whole chia seeds is used.

In one embodiment, the frozen food product may include about 0.1 to about 3 wt % flax, about 0.1 to about 4 wt % chia, or about 0.2 to about 7 wt % of a combination of flax and chia, based on the weight of the composition, with balance including water and fruit, and optional milk, optional nuts, optional additives, such as sugar, salt and/or vinegar additives, and/or optional additional fats. In another embodiment, the frozen food product may include about 0.1 to about 3 wt % flax, about 0.1 to about 4 wt % chia, 0.05 to 2% acacia fiber or about 0.2 to about 7 wt % of a combination of flax, chia, and acacia fiber based on the weight of the composition, with balance including water and fruit, and optional milk, optional nuts, optional additives, such as sugar, salt and/or vinegar additives, and/or optional additional fats.

Frozen food products include, but are not limited to, frozen sweets or ice confectionaries, which may include ice cream, ice milk, frozen yogurt, sorbet, or sherbet. One embodiment is non-dairy ice cream alternatives, such as fruit-based frozen treats or popsicles. Other embodiments include dairy-based ice creams.

The compositions may comprise fruit, such as dates, strawberries, blueberries (or other berries), bananas, cacao and/or cocoa (i.e., for chocolate flavor), coffee, lemon (e.g., lemon juice), orange (e.g., orange juice), and/or nuts, such as cashew and peanuts (e.g., peanut butter). The compositions may also include vegetables (e.g., beet) and natural flavors, such as salt (e.g., sea salt) and/or vinegar (e.g., balsamic vinegar). The balance of the composition comprises water (e.g., frozen water in the form of ice).

In one embodiment, the product is aerated. The freezing process introduces air (“overrun”). The addition of flax and/or chia seeds enable additional overrun. Further aeration improves the texture of the frozen food product.

In one embodiment, the frozen food product is substantially free of any additional sugars or “sugar additives” in addition to any whole or blended fruit that may be in the frozen food product. Such “sugar additives” include, but are not limited to honey, agave, maple syrup or any sugar derived from sugarcane, including but not limited to refined sugar, powdered sugar, whole cane sugar, and molasses.

In one embodiment, the frozen food product is substantially free of any dairy milk or dairy fats. In another embodiment, the frozen food product includes dairy milk, dairy fats and/or additional sugars.

The term “substantially free” or “essentially free” as used herein means that there is less than about 5% by weight of a specific material added to a composition, based on the total weight of the compositions. The compositions of the disclosure may be free of the components or may be “substantially free” or “essentially free” of the components described for optional inclusion in said compositions. Nonetheless, the compositions may include less than about 4%, less than about 3%, less than about 2%, less about 1%, less than about 0.5%, less than about 0.1%, less than about 0.01%, less than about 0.001%, or none of the specified material or components. Likewise, as used herein, the term “avoid” or “avoiding” the inclusion of a component means that there is less than about 5% by weight of a specific material added to a composition, based on the total weight of the compositions, such as less than about 4%, less than about 3%, less than about 2%, less about 1%, less than about 0.5%, less than about 0.1%, less than about 0.01%, less than about 0.001%, or none of the specified material or components.

In one embodiment, the frozen food product contains less than 0.1 wt % of industrial stabilizers, such as 0 to 0.05 wt % of the industrial stabilizers, such as carboxylmethylcellulose, xantham gum, guar gum, carrageenan, pectin, locust bean gum and sodium alginate.

The term “industrial” means a material that is not of natural origin, including, but not limited to, stabilizers derived from chemically altered plant material or chemically altered plant extracts. The term “natural” and “naturally-sourced” means a material of natural origin, such as derived from plants, which also cannot be subsequently chemically or physically modified. “Plant-based” means that the material came from a plant.

Unless otherwise expressly stated, it is in no way intended that any method set forth herein be construed as requiring that its steps be performed in a specific order. Accordingly, where a method claim does not expressly recite an order to be followed by its steps or it is not otherwise specifically stated in the claims or descriptions that the steps are to be limited to a specific order, it is no way intended that any particular order be inferred.

As used herein, the terms “comprising,” “having,” and “including” are used in their open, non-limiting sense.

The terms “a,” “an,” and “the” are understood to encompass the plural as well as the singular.

The expression “one or more” means “at least one” and thus includes individual components as well as mixtures/combinations.

Other than in the operating examples, or where otherwise indicated, all numbers expressing quantities of ingredients and/or reaction conditions are to be understood as being modified in all instances by the term “about,” meaning within +/−5%, 4%, 3%, 2%, or 1% of the indicated number. Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

All percentages, parts and ratios herein are based upon the total weight of the compositions of the present disclosure, unless otherwise indicated.

### EXAMPLES

When preparing the liquid food mixture to be frozen, add flax ratios of about 0.1 to about 3% by weight flax separately or in combination with chia ratios of about 0.1 to about 4% by weight chia, based on the weight of the composition. Allow sufficient time for flax and/or chia to solubilize aqueous mixtures, typically 5-30 minutes in the presence of water. Freeze mixture shortly thereafter to produce enhanced quality frozen product. The resulting frozen food products have a desired texture, ice crystal formation, and hardness as compared to frozen food products with industrial stabilizers.

Banana-based fruit ice creams have been demonstrated to reduce ice crystal formation, improve texture, and reduce hardness through the use of chia and flax seed stabilizers.

In addition to reducing fat and sugar content of frozen food by replacing a portion of the fat, sugar, or gluten/fiber, in addition to replacing the industrial stabilizers, additional health and nutritional benefits can be achieved with compositions that include flax and/or chia.

The FIGURE illustrates the functional nature of the superfoods reducing hardness of a final frozen food composition (e.g., frozen non-dairy ice cream alternative). The hardness is measured using TA.XT2 ice cream firmness measurement using an ice cream blade with a 30 kg load cell and 35 mm penetration. When the mixture contains no flax, no chia, and no additional emulsifiers or stabilizers (i.e., when the x axis value is zero), the resulting frozen food composition is at maximum hardness. As chia and flax are added to the composition, eventually the frozen food composition softens, and hardness is reduced. For individual recipes, optimization points may vary, as shown with two strawberry and peanut butter flavors. For the strawberry flavor composition that contains strawberry, the minimum hardness results between 4 and 5 wt % flax and chia. For the peanut butter flavor composition that contains peanut better, the minimum hardness results between 3 and 4 wt % flax and chia. In general, a hardness below 37,000 g/mm², such as 35,600 g/mm² to 36,800 g/mm² may be achieved.

Although the foregoing refers to particular preferred embodiments, it will be understood that the disclosure is not so limited. It will occur to those of ordinary skill in the art that various modifications may be made to the disclosed embodiments and that such modifications are intended to be within the scope of the disclosure.

1. A frozen food composition, wherein said composition comprises one or more stabilizers selected from the group consisting of chia or flax.

2. The composition of claim 1, wherein the one or more stabilizers comprises the chia.

3. The composition of claim 1, wherein one or more stabilizers is present in an amount that is about 0.1 to about 4% by weight chia based on the weight of the composition.

4. The composition of claim 1, wherein the one or more stabilizers comprises the flax which comprises ground flax.

5. The composition of claim 4, wherein one or more stabilizers is present in an amount that is about 0.1 to about 3% by weight flax based on the weight of the composition.

6. The composition of claim 1, wherein the one or more stabilizers comprises the chia and the flax.

7. The composition of claim 6, wherein the one or more stabilizers are present in an amount that is about 0.2 to about 7% by weight stabilizers based on the weight of the composition.

8. The composition of claim 1, wherein the one or more stabilizers further comprise about 0.05 to about 2% by weight acacia fiber.

9. The composition of claim 1, wherein the composition is a frozen sweet or ice confection.

10. The composition of claim 1, wherein the composition is selected from the group consisting of ice cream, ice milk, sorbet, sherbet or popsicle.

11. The composition of claim 1, wherein composition is substantially free of additional stabilizers.

12. The composition of claim 1, wherein at least 95% of the materials used in the composition are of natural origin.

13. The composition of claim 1, wherein the composition further comprises at least one or more sugar additives, or one or more dairy milk or dairy fat.

14. The composition of claim 1, wherein the composition is substantially free of sugar additives.

15. The composition of claim 1, wherein the composition is substantially free of dairy milk or dairy fat.

16. The composition of claim 1, wherein the composition further comprises
a) fruit and water;
b) fruit, nuts and water; or
c) water, salt, balsamic vinegar and at least one of fruit or nuts.

17. The composition of claim 1, wherein the composition is aerated.

18. A frozen food composition, wherein said composition comprises acacia fiber stabilizer.

19. The frozen food composition, wherein said composition further comprising one or more additional stabilizers selected from the group consisting of chia or flax.

20. A liquid food composition for freezing with aeration wherein said composition comprises one or more stabilizers selected from chia or flax.

21. The liquid food composition of claim 20, wherein the one or more stabilizers further comprises acacia fiber.

22. A method of making the frozen food composition of claim 1, wherein said method comprises:
a) mixing a liquid food composition with one or more solublized stabilizers selected from chia or flax, and
b) freezing said mixture.

23. The method of claim 22, further comprising aerating the mixture.
